(19) United States
(12) Patent Application Publication
(10) Pub. No.: US 2008/0096399 A1
(43) Pub. Date: Apr. 24, 2008

(54) Heat Dissipating Terminal and Electrical Connector Using Same

(75) Inventor: Kok Meng Goh, Singapore (SG)

Correspondence Address: MOLEX INCORPORATED, 2222 WELLINGTON COURT, LISLE, IL, 60532, US

(73) Assignee: Molex Incorporated, Lisle, IL (US)

(21) Appl. No.: 11/664,179

(22) PCT Filed: Sep. 16, 2005
(86) PCT No.: PCT/US05/33224

§ 371 Date: Sep. 26, 2007

(30) Foreign Application Priority Data
Oct. 1, 2004 (SG) 200405595-0

(51) Int. Cl. H01R 13/533; H01R 12/30

(52) U.S. Cl. 439/55; 439/487

(57) ABSTRACT

An electrically conductive terminal 2, 3 for a circuit board connector has a heat sink fin 16 which is thermally coupled to two connection portions 12, 14 for dissipation of heat generated in the connection portions. The heat sink fin and one of the connection portions 12 extend from a central body portion 10 in the same direction. The heat sink fin is preferably located outside one of the connection portions 12 to protect the latter from physical damage. A lock portion 18, with a barb 26 for retaining the terminal in the connector housing 1, may extend from the central body portion in a direction opposite to the heat sink fin 16. The terminal 2, 3, and particularly the lock portion 18, can be inserted into a cavity 28 in the connector housing 1 by pushing on the distal end 24 of the heat sink fin. The terminal may be stamped from a sheet metal material. Also claimed is a connector having a row of such terminals mounted with a common alignment and with the heat sink fins located outside the connector housing.

### FIELD OF THE INVENTION

The present invention relates to electrical connectors, particularly to electrical connectors for printed circuit boards, and has application to printed circuit board edge connectors for high current applications such as voltage regulator or other power supply modules.

### BACKGROUND OF THE INVENTION

The invention has application to the electrical interconnection of modules, i.e. assemblies of electrical components, to printed circuit boards. It is known to use dedicated connectors having a row or rows of terminals mounted in an elongate housing. Each terminal has a connection tail for connection, e.g. by soldering, to a respective conductive track on the circuit board, and a socket portion for releasable connection to the module. The module may be a circuit board which is supported and connected by the connector to another printed circuit board. In this case the module and the other printed circuit board may be respectively referred to as a ‘daughter board’ and a ‘mother board’. An edge of the ‘daughter board’ is typically received in a slot or other guide means in a housing of the connector so that terminal socket portions of the connector are in registration with respective conductive pads on the daughter board.

The dedicated connectors can be mounted wholly on one side of the motherboard or alternatively can be mounted to straddle an edge portion of the motherboard. In the latter arrangement, the connecting terminals of the so-called ‘straddle mount’ connectors are located much closer to the plane of the circuit board and can be configured with a much shorter length than in the former one-sided arrangement.

U.S. Pat. No. 5,522,737 describes an edge connector for mounting on a printed circuit board. The characteristic impedance of the connector may be tuned to suit the impedance of circuits to be interconnected with the connector. The connector has signal terminals with a mechanically non-functional portion which, in conjunction with an enlarged area of an adjacent ground terminal, effects a given capacitance. The signal terminal portions may be trimmed to vary this capacitance, and thereby the impedance of the connector, so that the connector impedance may be matched to the given impedance of the electrical circuit. The enlarged area of the ground terminals is also said to contribute to an increased electrical isolation and a reduction of cross-talk.

U.S. Pat. No. 5,893,764 describes an electrical connector for straddle mounting to the edge of a printed circuit board. The connector has a row of terminals located in an elongate housing. Terminal tail portions extend from the housing for soldered connection to circuit traces on the opposite surfaces of the circuit board. A U-shaped mounting clip is fitted at each end of the housing for securing the circuit board to the housing.

U.S. Pat. No. 6,238,218 describes a device for electrically connecting a coaxial line to a printed circuit card. The device has an outer contact with a tubular portion. Two diametrically opposed slots subdivide the tubular portion into two jaws. A centre contact inside the outer contact has a clip into which the edge of the card is engaged when the card is inserted between the two jaws of the outer contact. The inner and outer contacts make electrical connection to respective conductor tracks on the circuit card.

U.S. Pat. No. 6,692,273 describes a straddle mount connector for connection to a printed circuit board. The connector signal contacts have terminal portions which extend through slits between fingers extending from ground buses. Provision is made to allow the terminal portions of the signal contacts to be accurately aligned with signal pads on the printed circuit board.

When circuit board connectors are used for connection of power supply modules or sub-assemblies, and particularly for interconnections involving relatively high currents, one problem that arises is the dissipation of heat generated by the currents in the connector. In the connectors of the prior art discussed above, there is no specific adaptation made to enhance the dissipation of heat from the connector.

### SUMMARY OF THE INVENTION

An object of at least one embodiment of the invention is to provide a circuit board connector terminal with a means for dissipating heat, or at least to provide the public with a useful choice.

Another object of at least one embodiment of the invention is to provide a circuit board connector with a means for dissipating heat.

In a first aspect the invention may be broadly said to be an electrically conductive terminal, for use in a connector for electrically interconnecting a printed circuit board and a circuit module, the terminal having a central body portion, a first connection portion for electrical connection of the terminal to a conductive track on a first major surface of the circuit board, a second connection portion for electrical connection of the terminal to the circuit module, and a first heat sink portion for dissipation of heat generated by a flow of electrical current through the terminal.

The first and second connection portions preferably each extend from the central body portion. The first and second connection portions may each extend from the central body portion in substantially opposite directions.

The first heat sink portion is preferably thermally connected to the first and second connection portions and may be physically connected to the first and second connection portions.

The first heat sink portion is preferably thermally connected to the central body portion and may be physically connected to the central body portion. The first heat sink portion and the first connection portion may each extend from the central body portion in substantially the same direction. Alternatively the first heat sink portion and the first connection portion may each extend from the central body portion in substantially the opposite direction.

Preferably, the first connection portion has a contact surface for electrically conductive abutment with the conductive track on the first major surface of the circuit board, and the first heat sink portion is located adjacent a side of the first connection portion that is opposite to the contact surface.

The first heat sink portion and the first connection portion preferably extend from the central body portion to respective distal ends, and the distal end of the first connection portion is preferably not further from the central body portion than the distal end of the heat sink portion.

The first heat sink portion and the first connection portion may be spaced apart from one another.

The terminal may have a first lock portion for locking engagement with a housing of the connector. The first lock portion may extend from the central body portion. The first lock portion and the first heat sink portion may extend from the central body portion in opposite directions.

The terminal may be made from a metal and may be stamped from a sheet material.

Optionally, the terminal has a third connection portion for electrical connection of the terminal to a conductive track on a second major surface of the circuit board, the second major surface being opposite the first major surface, and the terminal has a fourth connection portion for electrical connection of the terminal to the circuit module. The terminal may also have a second heat sink portion for dissipation of heat generated by a flow of electrical current through the terminal.

The third and fourth connection portions preferably each extend from the central body portion (10). The extension may be in substantially opposite directions.

The second heat sink portion is preferably thermally connected to the third and fourth connection portions. The second heat sink portion may be physically connected to the third and fourth connection portions.

The second heat sink portion may be thermally connected to the central body portion and may also be physically connected to the central body portion.

Preferably the third connection portion has a contact surface for electrically conductive abutment with the conductive track on the second major surface of the circuit board, and the second heat sink portion is located adjacent a side of the third connection portion that is opposite to the contact surface.

The second heat sink portion and the third connection portion preferably each extend from the central body portion in substantially the same direction. Alternatively the second heat sink portion and the third connection portion may each extend from the central body portion in substantially the opposite direction.

Optionally the terminal may have a second lock portion for locking engagement with a housing of the connector. The second lock portion may extend from the central body portion. The second lock portion and the third heat sink portion may extend from the central body portion in opposite directions.

In a second aspect the invention may be broadly said to be a connector for electrically interconnecting a printed circuit board and a circuit module, the connector having a dielectric housing in which is mounted a row of spaced apart terminals, wherein each terminal is as defined above as the first aspect of the invention or any one of the preferences or optional arrangements of the first aspect. The heat sink portions are preferably located outside the dielectric housing.

The invention may further be said to consist in any alternative combination of parts or features mentioned herein or shown in the accompanying drawings. Known equivalents of these parts or features which are not expressly set out are nevertheless deemed to be included.

### BRIEF DESCRIPTION OF THE DRAWINGS

Disclosed embodiments and methods of utilizing the invention will be further described, with reference to the accompanying FIGS., by way of example only and without intending to be limiting, wherein;

FIG. 1 shows a perspective view of a connector according to the disclosed embodiment of the invention,

FIG. 2A shows a cross-sectional view of the connector as seen at line X-X of FIG. 1,

FIG. 2B shows a cross-sectional view of the connector as seen at line Y-Y of FIG. 1,

FIG. 3 shows a perspective view of a fragment of the connector of FIGS. 1, 2A and 2B, in a first pre-assembled state with two terminal sets about to be inserted in a housing,

FIG. 4 shows a perspective view of the fragment of the connector shown in FIG. 3, in a second pre-assembled state with the two terminal sets inserted in the housing,

FIG. 5 shows a perspective view of the connector of FIGS. 1 to 4 with a circuit board (shown in part only) aligned ready for coupling to the connector,

FIG. 6 shows a perspective view of the connector of FIGS. 1 to 5 with a circuit board and a module card (each shown in part only) coupled to the connector, and

FIG. 7A shows a cross-sectional view of the connector, board and card (the latter two shown in part only) as seen at line Z1-Z1 of FIG. 6 showing an integral pair of electrically connected alike sub-sections.

FIG. 7B shows a cross-sectional view of the connector, board and card (the latter two shown in part only) as seen at line Z2-Z2 of FIG. 6 showing a pair of electrically unconnected but alike sub-sections.

### DETAILED DESCRIPTION OF THE DISCLOSED EMBODIMENTS

Referring to the FIGS. it will be appreciated that the invention may be implemented in various forms and modes. The following description of the disclosed embodiment of the invention is given by way of example only.

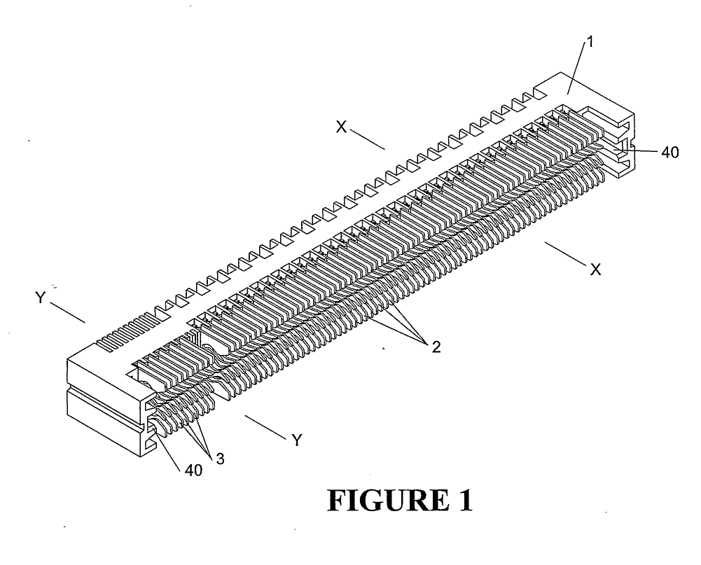

FIG. 1 shows a straddle-mount edge connector adapted for fitting over an edge portion of a printed circuit board. The connector has a dielectric housing 1 in which discrete electrically conductive terminals 2, 3 are mounted. In one typical application the connector is used as a straddle-mounted edge connector for mounting and connecting a voltage regulator module (VRM) to a peripheral edge of a printed circuit board (PCB), as will be explained in more detail below.

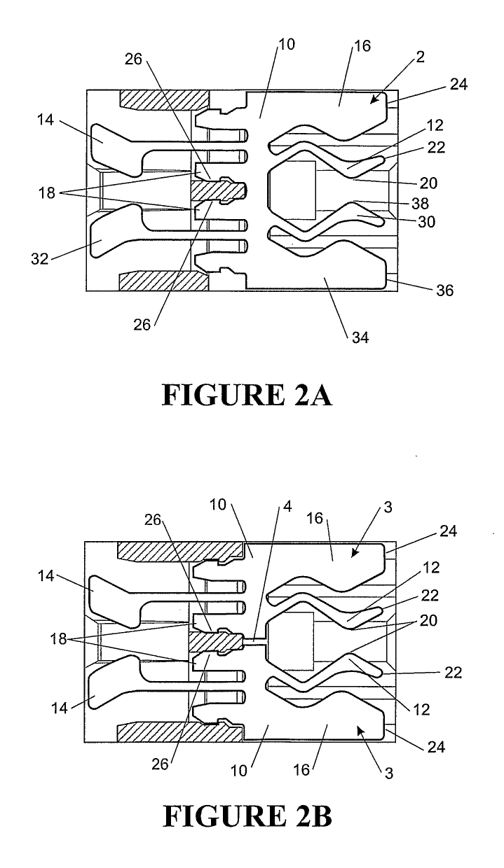

The terminals 2, 3 are flat, mutually parallel, spaced apart, and commonly aligned in a row in the connector housing 1. The terminals are preferably made from metal by stamping from a thin sheet or strip. The form of the terminals 2, 3 may be better appreciated from the respective cross-sectional views shown in FIGS. 2A and 2B.

FIG. 2A shows a first type of terminal 2 which is formed as an integral pair of alike terminal sub-sections that are electrically connected together and symmetrically arranged (in FIG. 2A as respective upper and lower sub-sections).

FIG. 2B shows two of a second type of terminal 3. These terminals 3 are discrete and are each shaped like the sub-sections of the first type of terminal 2. Terminals 3 of the second type are symmetrically mounted in the connector housing 1 in pairs. In each mounted pair, the terminals 3 are spaced apart by a gap 4.

Each of the terminals 2, 3 has a central body portion 10 from which are cantilevered first and second connection portions being, respectively, a first connection tail 12 and a first receptacle contact 14. Also extending from the central body portion 10 of each terminal are a first heat sink portion or fin 16 and lock portions 18. The heat sink fin 16 is coupled to the connection tail 12 and receptacle contact 14 via the central body 10. The central body provides a thermally conductive connection from the connection tail 12 and the receptacle contact 14 to the heat sink fin 16.

The first connection tail 12 has a contact surface 20 for connection of the first connection tail to a respective conductive track on one of the two major surfaces of a printed circuit board, as will be explained further below. It will be appreciated that in terminals 3 of the second type, the contact surfaces 20 of first connection tails 12 of respective terminals of a pair (as shown in FIG. 2B) can simultaneously make independent connection with respective conductive tracks on opposite sides of a circuit board coupled to the connector.

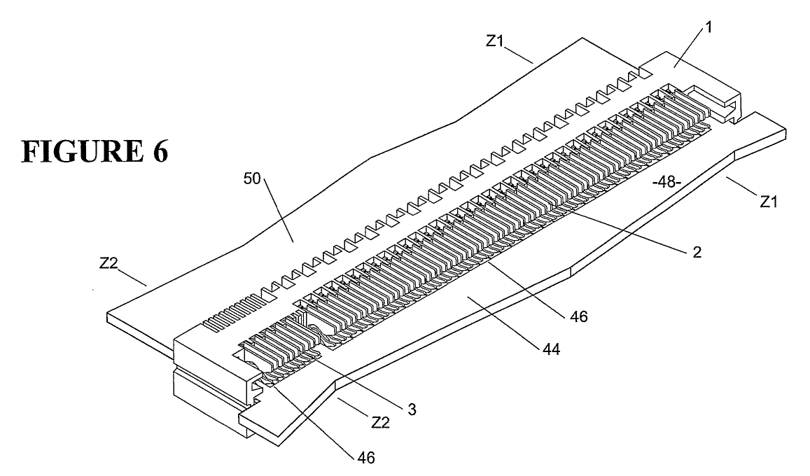

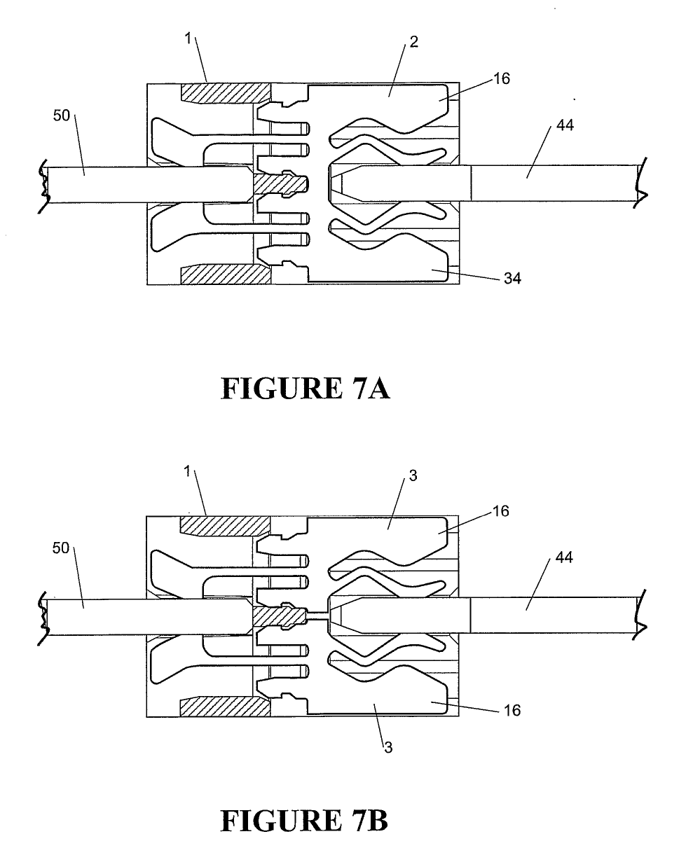

The heat sink fin 16 is located on a side of the first connection tail 12 opposite to the contact surface 20. When the connector is attached to a circuit board (for example, as shown in FIGS. 6 and 7) the heat sink fin 16 is on the outside of the connector tail 12. In other words, the heat sink fin 16 is located furthest away from the circuit board so as to minimise the likelihood that the heat dissipated by the heat sink fin 16 will be reabsorbed by the circuit board.

The first connection tail 12 and the heat sink fin 16 each extend from the central body portion 10 in the same direction to respective distal ends 22, 24. The heat sink fin and the first connection tail are spaced apart to give room for the tail to flex under its inherent resilience when a circuit board is coupled to the terminal.

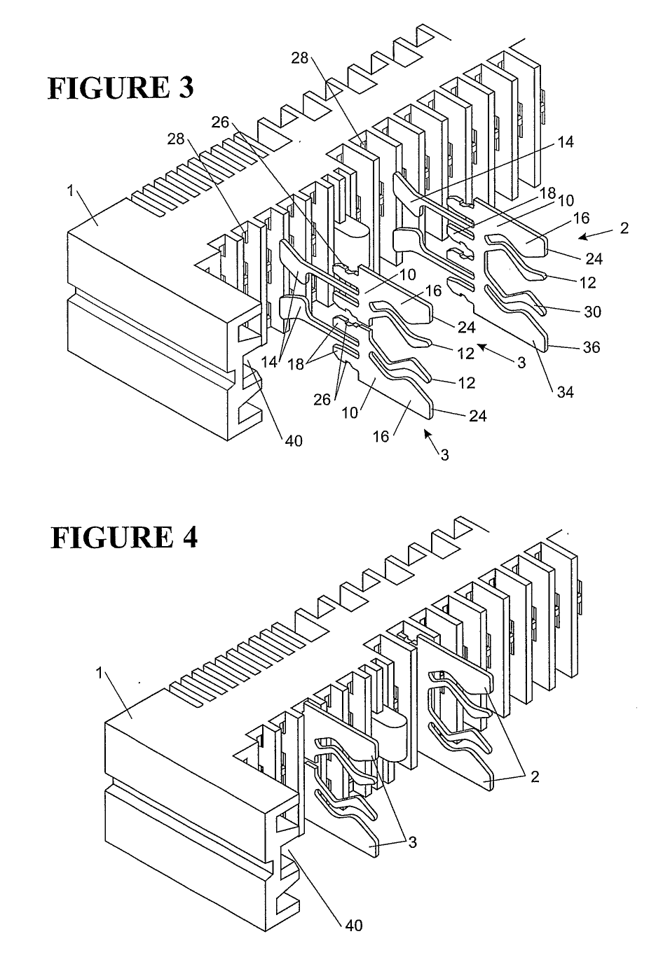

Each lock portion 18 has a barb 26 which engages with the housing to lockingly retain the respective terminal in the housing. The lock portion 18 and the heat sink fin 16 extend from the central body 10 of the terminal 2, 3 in opposite directions so that the terminal, and particularly the lock portion, may be inserted into a respective cavity 28 (as may be best seen in FIG. 3) provided in the housing 1, by pressing on the distal end 24 of the heat sink fin 16. This may be best appreciated by reference to FIGS. 3 and 4 which respectively show terminals 2 and 3 aligned ready for insertion, and then inserted, into the housing 1.

In the embodiment shown in the FIGS. the first connection tail 12 and the first heat sink fin 16 each extend to distal ends 22, 24 that are aligned at equal distances from the central body 10. However, in an alternative, not shown, the distal ends 24 of the heat sink fins 16 are further from the central body 10 than the distal ends 22 of the connection tails 12.

The extension of the heat sink fin 16 at least as far as that of the connection tail 12 allows the distal end 24 of the heat sink fin, which has a generally planer end surface, to be used to push against when inserting the terminal into the housing during assembly of the connector without, or without significantly pushing on the connection tail.

FIGS. 2A and 3 show that the terminals 2 of the first type (formed with the integral, and therefore interconnected, pair of alike sub-sections) also have, in a second of the sub-sections, third and fourth connection portions being respectively a second connection tail 30 and a second receptacle contact 32. Each of these connection portions is cantilevered from the central body portion 10 which is common to both sub-sections of the terminal. A second heat sink fin 34 also extends from the central body portion 10 to a distal end 36. The second heat sink fin 34 is coupled to the second connection tail 30 and the second receptacle contact 32 via the central body 10 which provides a thermally conductive connection from these connection portions 30, 32 to the second heat sink fin 34.

The second connection tail 30 has a contact surface 38 for connection to a conductive track or pad on a second of the two major surfaces of a printed circuit board. The second heat sink fin 34 is located on a side of the second connection tail 30 opposite its contact surface 38.

The respective distal ends 24, 36 of the heat sink fins 16, 34 provide a useful datum on the terminals 2, 3 to provide stability and ease of insertion of the terminal in the connector housing 1 during assembly of the connector. The heat sink fins 16, 34 being more substantially dimensioned than the connection tails 12, 30, provide a more robust datum for engaging and pushing against during insertion of the terminals 2, 3 in the connector housing 1 and reduces the likelihood of the connection tails from being damaged during this insertion.

The terminals are installed into the housing with the heat sink portions of the terminals mutually parallel and located outside the dielectric housing, as may be appreciated particularly from FIGS. 1, 5 and 6.

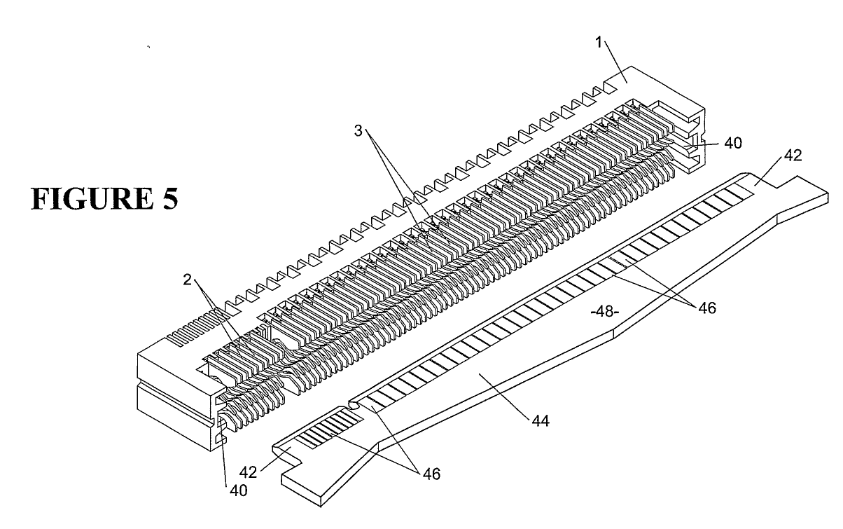

The connector housing 1 has a pair of guide slots 40 in which edge portions 42 of a circuit board 44 (a fragment of which is shown in FIGS. 5, 6 and 7) may be inserted to bring conductive tracks or pads 46 in a row along an edge portion of a major surface 48 of the circuit board into registration with respective connection tails 12, 30 of the terminals 2, 3. The connection tails 12, 30 may be soldered to the respective conductive pads 46.

FIG. 6 shows a fragment of a second circuit board or module card 50 as fitted to the connector. The terminal receptacle contacts 14, 32 make electrical contact with respective conductive tracks or pads on the module card. This contact is maintained by resilient pressure of the cantilevered receptacle contacts 14, 32 on the respective conductive tracks of the module card rather than by soldering as described above, so that the module card is readily removable from the connector, e.g. for repair or replacement of the module.

FIGS. 7A and 7 B show a module card 50 interconnected via the connector to the printed circuit board 44 with the row of connector terminals 2, 3 providing a series of electrically conductive pathways between the module and the circuit board. The heat sink fins 16, 34 greatly enhance the dissipation of heat generated by current flowing in these connections. The thermal dissipation provided by the heat sink fins is further enhanced by not confining the fins inside the dielectric housing 1. The heat sink fins are located outside of the housing where they are exposed to ambient air.

The heat sink fins 16, 34 provide a relatively large surface area for this dissipation of heat from the terminals 2, 3 to ambient air. Although the heat sink portions 16, 34 of the terminals 2, 3 are relatively large, the heat sink portions 16, 34 likewise have a large surface area which is necessary to allow heat to dissipate to the outside environment rather than becoming a thermal mass that retains heat. This makes the terminals and the edge connector particularly suitable for relatively high current applications where any temperature rise in the connector is preferably kept low and stable. Typical applications of connectors using the terminals described include connection of power supplies or voltage regulator modules to a printed circuit motherboard, the so-called VRM edge connectors.

Furthermore, the heat sink fins, being outside the connection tails 12, 30, shield the tails from physical damage such as might occur during reeling and other handling processes subsequent to stamping of the terminals. Physical damage and particularly any bending or distortion of the connection tails prior to soldering to the conductive tracks on the circuit board can cause mis-registration of the connection tails to their respective conductive tracks. A lack of registration can result in shorting between adjacent terminal circuits or a lack of an intended connection. The physical shielding provided by the heat sinks fins is therefore particularly advantageous in connectors having a small terminal pitch.

The foregoing describes the invention with reference to the disclosed embodiment. Alterations and modifications as will be obvious to those skilled in the art are intended to be incorporated within the scope of the invention as defined in the accompanying claims. For example, although the disclosed embodiment described above is an edge connector for straddle mounting over the edge of a printed circuit board, the heat sink fins are similarly applicable to a connector adapted for attachment and connection to only one major surface of a circuit board.

What is claimed is:

1. An electrically conductive terminal, for use in a connector for electrically interconnecting a printed circuit board and a circuit module, the terminal having a central body portion, a first connection portion for electrical connection of the terminal to a conductive track on a first major surface of the circuit board, a second connection portion for electrical connection of the terminal to the circuit module, and a first heat sink portion for dissipation of heat generated by a flow of electrical current through the terminal, wherein each of the first connection portion, the second connection portion and the first heat sink portion are physically interconnected by the central body portion, and wherein the first heat sink portion is not located between the first connection portion and the second connection portion.

2. An electrically conductive terminal as claimed in claim 1, wherein the first and second connection portions each extend from the central body portion.

3. An electrically conductive terminal as claimed in claim 2, wherein the first and second connection portions extend from the central body portion in substantially opposite directions.

4. An electrically conductive terminal as claimed in claim 1, wherein the first heat sink portion is thermally connected to the first and second connection portions.

5. An electrically conductive terminal as claimed in claim 1, wherein the first heat sink portion is physically connected to the first and second connection portions.

6. An electrically conductive terminal as claimed in claim 1, wherein the first heat sink portion is thermally connected to the central body portion.

7. An electrically conductive terminal as claimed in claim 1, wherein the first heat sink portion is physically connected to the central body portion.

8. An electrically conductive terminal as claimed in claim 1, wherein the first connection portion has a contact surface for electrically conductive abutment with the conductive track on the first major surface of the circuit board, and the first heat sink portion is located adjacent a side of the first connection portion that is opposite to the contact surface.

9. An electrically conductive terminal as claimed in claim 1, wherein the first heat sink portion and the first connection portion each extend from the central body portion in substantially the same direction.

10. An electrically conductive terminal as claimed in claim 1, wherein the first heat sink portion and the first connection portion each extend from the central body portion in substantially the opposite direction.

11. An electrically conductive terminal as claimed in claim 1, wherein the first heat sink portion and the first connection portion extend from the central body portion to respective distal ends, and the distal end of the first connection portion is not further from the central body portion than the distal end of the heat sink portion.

12. An electrically conductive terminal as claimed in claim 1, wherein the terminal has a first lock portion for locking engagement with a housing of the connector.

13. An electrically conductive terminal as claimed in claim 12, wherein the first lock portion extends from the central body portion.

14. An electrically conductive terminal as claimed in claim 13, wherein the first lock portion and the first heat sink portion extend from the central body portion in opposite directions.

15. An electrically conductive terminal as claimed in claim 1, wherein the first heat sink portion and the first connection portion are spaced apart from one another.

16. An electrically conductive terminal as claimed in claim 1, wherein the terminal is made from a metal.

17. An electrically conductive terminal as claimed in claim 1, wherein the terminal is stamped from a sheet material.

18. An electrically conductive terminal as-claimed in claim 1, the terminal having a third connection portion for electrical connection of the terminal to a conductive track on a second major surface of the circuit board, the second major surface being opposite the first major surface, the terminal having a fourth connection portion for electrical connection of the terminal to the circuit module, and the terminal having a second heat sink portion for dissipation of heat generated by a flow of electrical current through the terminal.

19. An electrically conductive terminal as claimed in claim 18, wherein the third and fourth connection portions each extend from the central body portion.

20. An electrically conductive terminal as claimed in claim 19, wherein the third and fourth connection portions extend from the central body portion in substantially opposite directions.

21. An electrically conductive terminal as claimed in claim 18, wherein the second heat sink portion is thermally connected to the third and fourth connection portions.

22. An electrically conductive terminal as claimed in claim 18, wherein the second heat sink portion is physically connected to the third and fourth connection portions.

23. An electrically conductive terminal as claimed in claim 18, wherein the second heat sink portion is thermally connected to the central body portion.

24. An electrically conductive terminal as claimed in claim 18, wherein the second heat sink portion is physically connected to the central body portion.

25. An electrically conductive terminal as claimed in claim 18, wherein the third connection portion has a contact surface for electrically conductive abutment with the conductive track on the second major surface of the circuit board, and the second heat sink portion is located adjacent a side of the third connection portion that is opposite to the contact surface.

26. An electrically conductive terminal as claimed in claim 18, wherein the second heat sink portion and the third connection portion each extend from the central body portion in substantially the same direction.

27. An electrically conductive terminal as claimed in claim 18, wherein the second heat sink portion and the third connection portion each extend from the central body portion in substantially the opposite direction.

28. An electrically conductive terminal as claimed in claim 18, wherein the terminal has a second lock portion for locking engagement with a housing of the connector.

29. An electrically conductive terminal as claimed in claim 28, wherein the second lock portion extends from the central body portion.

30. An electrically conductive terminal as claimed in claim 29, wherein the second lock portion and the first heat sink portion extend from the central body portion in opposite directions.

31. A connector for electrically interconnecting a printed circuit board and a circuit module, the connector having a dielectric housing in which is mounted a row of spaced apart terminals, wherein each terminal is as claimed in claim 1.

32. A connector as claimed in claim 31, wherein the heat sink portions are located outside the dielectric housing.
